(19) United States
(12) Patent Application Publication
(10) Pub. No.: US 2018/0349841 A1
(43) Pub. Date: Dec. 6, 2018

(54) SYSTEM AND METHOD FOR TAKING ACTIONS UPON REFRIGERATION UNIT FAILURE IN A VEHICLE

(71) Applicant: Walmart Apollo, LLC, Bentonville, AR (US)

(72) Inventors: Greg A. Bryan, Centerton, AR (US); Benjamin D. Enssle, Bella Vista, AR (US); Cristy C. Brooks, Cassville, MO (US); David C. Winkle, Bella Vista, AR (US); John P. Thompson, Bentonville, AR (US); Bruce W. Wilkinson, Rogers, AR (US)

(21) Appl. No.: 15/978,441

(22) Filed: May 14, 2018

Related U.S. Application Data
(60) Provisional application No. 62/512,787, filed on May 31, 2017.

(51) Int. Cl. G06Q 10/08; G06F 17/30; G01C 21/34

(52) U.S. Cl. CPC G06Q 10/0832; G06F 17/30675; G06Q 10/08355; B60P 3/20; G01C 21/3415; G01C 21/3453; G06Q 10/0833

(57) ABSTRACT

A data structure is stored at a central processing center. The data structure includes product information concerning financial characteristics and physical characteristics of the product, and destination location information indicating geographic coordinates of potential destinations for placement the product. At the central processing center, a failure indication indicating that the refrigeration unit has failed is received. The data structure in the database is accessed to obtain the product information and the destination location information. A product preservation action is determined based upon an analysis of the product information and the destination location information associated with the product.

### CROSS-REFERENCE TO RELATED APPLICATION

This application claims the benefit of the following U.S. Provisional Application No. 62/512,787 filed May 31, 2017, which is incorporated herein by reference in its entirety.

### TECHNICAL FIELD

These teachings relate generally to vehicles that include refrigeration units and, more specifically, actions taken involving these vehicles when the refrigeration unit on a vehicle fails.

### BACKGROUND

Vehicles transport various types of goods from location to location. Perishable products are transported and typically require the use of a refrigeration unit to ensure that these products do not perish and become unusable. Unfortunately, sometimes the refrigeration unit fails.

Previous approaches of handing the failure of the refrigeration unit relied upon the judgment and knowledge of the driver of the vehicle to deal with the situation. For example, the driver may, from their own memory, determine where the nearest delivery location was located, and drive to that location. In other situations, the driver may not even be aware the refrigeration unit had failed, so the driver would take no action.

In any case, previous approaches were typically ah-hoc, relied on the knowledge and experience of the driver, and resulted in the inefficient allocation of vehicle resources. Additionally, products were lost due to these problems resulting in financial losses for shipping companies, businesses, and their customers.

### BRIEF DESCRIPTION OF THE DRAWINGS

The above needs are at least partially met through provision of approaches that take actions upon vehicular refrigeration unit failure, particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings; and

FIG. 3 comprises a flowchart as configured in accordance with various embodiments of these teachings.

### DETAILED DESCRIPTION

Generally speaking, many of these embodiments provide for a system and method that upon the failure of a refrigeration unit in a vehicle, an appropriate action is determined and taken. Various actions that can be taken include re-routing the truck to a destination, discarding products, or moving products within the truck to mention a few examples. In aspects, the nature of the action taken depends upon financial characteristics of the products and the location of alternative destinations.

In many of these embodiments, a system of re-routing vehicles (carrying refrigerated products) in the event of a refrigeration failure includes a communication network, a vehicle, a database, and a control circuit. The vehicle includes a transceiver circuit and the transceiver circuit is communicatively coupled to the network. The vehicle also includes a refrigeration unit that is configured to maintain a predetermined temperature for a product within a storage area of the vehicle. The vehicle additionally includes a failure detection sensor configured to detect an operational failure of the refrigeration unit.

The database is disposed at a central processing center and stores a data structure. The data structure includes product information concerning financial characteristics and physical characteristics of the product, and destination location information indicating geographic coordinates of potential destinations for placement the product.

The control circuit is disposed at the central processing center and is communicatively coupled to the network. The control circuit is configured to receive a failure indication indicating that the refrigeration unit has failed. The failure indication is received from the transceiver circuit of the vehicle via the network. In examples, the failure indication may indicate partial or complete failure. The control circuit is configured to access the data structure in the database and obtain the product information and the destination location information. The control circuit is configured to determine a product preservation action based upon an analysis of the product information and the destination location information associated with the product.

In aspects, the control circuit determines a product preservation action at least in part by determining whether one or more of the following conditions exist: (a) a financial characteristic of the product exceeds a first threshold: (b) a potential location is located more than a threshold distance from a current location; and (c) a physical characteristic of the product exceeds a second threshold. In other aspects, the product information includes one or more of: a cost of the product, a profitability of the product, and a demand for the product. In yet other examples, the product information includes one or more of: dimensions of the product and cooling requirements of the product.

In still other aspects, the failure indication is obtained from sensors at the vehicle or a report from the driver of the vehicle. In yet other examples, the failure indication indicates one or more of: a status of the refrigeration unit, a temperature of the air being produced by the refrigeration unit, or a temperature of the storage area.

In other examples, the storage space is divided into multiple zones. For instance, the vehicle is divided into a first zone and a second zone, the product is disposed in the first zone and a second product is disposed in a second zone, and the control circuit is configured to determine a preservation priority as between preserving the product and the second product.

In yet other examples, the database is further configured to store environmental factors. The environmental factors include an outside temperature that is external to the vehicle, and the environmental factors are considered in the analysis.

In still other aspects, the product preservation action is one of: re-routing the vehicle and any accompanying product invoicing data in an inventory tracking system from an original destination to a new destination, moving the product within the vehicle, or discarding the product.

In others of these embodiments, a refrigeration unit is operated in a vehicle. The refrigeration unit is configured to maintain a predetermined temperature for a product within a storage area of the vehicle.

A data structure is stored at a central processing center. The data structure includes product information concerning financial characteristics and physical characteristics of the product, and destination location information indicating geographic coordinates of potential destinations for placement the product.

At the central processing center, a failure indication (indicating that the refrigeration unit has failed) is received. The data structure in the database is accessed to obtain the product information and the destination location information. A product preservation action is determined based upon an analysis of the product information and the destination location information associated with the product.

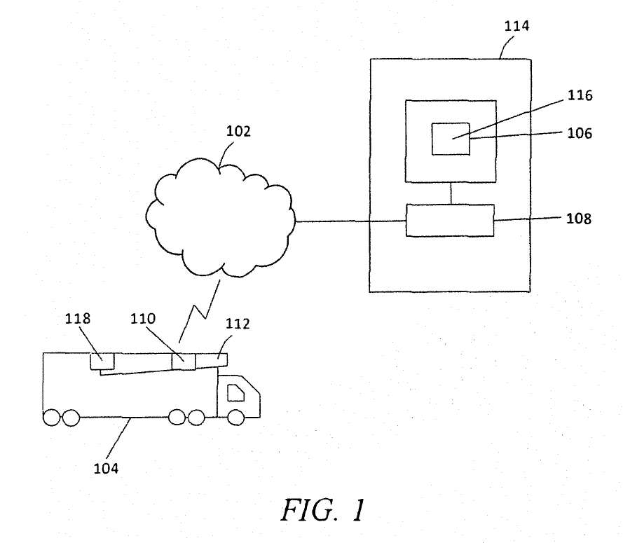

Referring now to FIG. 1, a system for re-routing vehicles (carrying refrigerated products) in the event of a refrigeration failure includes a communication network 102, a vehicle 104, a database 106, and a control circuit 108. The vehicle 104 includes a transceiver circuit 110 and the transceiver circuit 110 is communicatively coupled to the network 102. The vehicle 104 also includes a refrigeration unit 112 that is configured to maintain a predetermined temperature for a product within a storage area of the vehicle 104.

The communication network 102 may be any network or combination of networks. In examples, the network 102 may be the cloud, the internet, cellular networks, local or wide area networks, or any combination of these (or other) networks. The network 102 may include various electronic devices (e.g., routers, gateways, and/or processors to mention a few examples).

The vehicle 104 is any vehicle such as a truck, tractor-trailer, or automobile that is configured to store and transport products. The vehicle includes the refrigeration unit 112, which is configured to maintain a temperature in one or more areas of the vehicle 104 in order to preserve the products. In other examples, the vehicle 104 may be divided into various zones. In one specific example, the vehicle is divided into a first zone and a second zone (e.g., separated by bulkheads), and the product is disposed in the first zone and a second product is disposed in a second zone. Each zone may be maintained at the same or a different temperature.

The transceiver circuit 110 is configured to transmit and receive information from the vehicle 104. The transceiver circuit 110 may allow a driver in the vehicle 104 via the network 102 to transmit and receive messages from the central control center 114. The transceiver circuit 110 is coupled to the refrigeration unit 112, and the transceiver circuit 110 receives a failure indication from the refrigeration unit 112 when the refrigeration unit 112 fails. A failure indication sensor (one of sensors 118) may deployed at the unit 112 may sense failure of the unit 112. The failure at the refrigeration unit 112 may be a complete failure (e.g., the unit has shut down), or a partial failure (e.g., the unit is still running, but running inefficiently or ineffectively). One or more sensors 118 may be deployed at the vehicle 102 and the sensors 118 are coupled to the transceiver circuit 110. The transceiver circuit 110 may include any combination of electronic hardware and software that transmits and receives information.

The database 106 is disposed at a central processing center 114 and stores a data structure 116. The data structure 116 includes product information concerning financial characteristics and physical characteristics of the product, and destination location information indicating geographic coordinates of potential destinations for placement the product. In yet other examples, the database 106 is further configured to store environmental factors. The environmental factors include an outside temperature that is external to the vehicle (e.g., readings obtained by sensors 118), and the environmental factors are considered in the analysis.

The control circuit 108 is disposed at the central processing center 114 and is communicatively coupled to the network 102. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 is configured to receive a failure indication indicating that the refrigeration unit 112 has failed. The failure indication is received from the transceiver circuit 110 of the vehicle 104 via the network 102. The control circuit 108 is configured to access the data structure 116 in the database 106 and obtain the product information and the destination location information. The control circuit 108 is configured to determine a product preservation action based upon an analysis of the product information and the destination location information associated with the product.

In aspects, the control circuit 108 determines a product preservation action at least in part by determining whether one or more of the following conditions exist: (a) a financial characteristic of the product exceeds a first threshold; (b) a potential location is located more than a threshold distance from a current location of the product; and (c) a physical characteristic of the product exceeds a second threshold. In aspects, the product information includes one or more of: a cost of the product, a profitability of the product, and a demand for the product. In examples, the product information includes one or more of: dimensions of the product and cooling requirements of the product.

In still other aspects, the failure indication is obtained from sensors 118 (e.g., a dedicated failure detection sensor) at the vehicle 104 or a report from the driver of the vehicle 104. The failure indication may be any electronic signal of any format and transmitted according to any protocol. In examples, the failure indication indicates one or more of: a status of the refrigeration unit, a temperature of the air being produced by the refrigeration unit, or a temperature of the storage area.

In still other aspects, the product preservation action is re-routing the vehicle 104 (and any accompanying product invoicing data in an inventory tracking system) from an original destination to a new destination, moving the product within the vehicle 104, or discarding the product. Other examples of product preservation actions are possible.

In one example, the vehicle 104 is divided into a first zone and a second zone, the product is disposed in the first zone and a second product is disposed in a second zone, and wherein the control circuit 108 is configured to determine a preservation priority as between preserving the product and the second product.

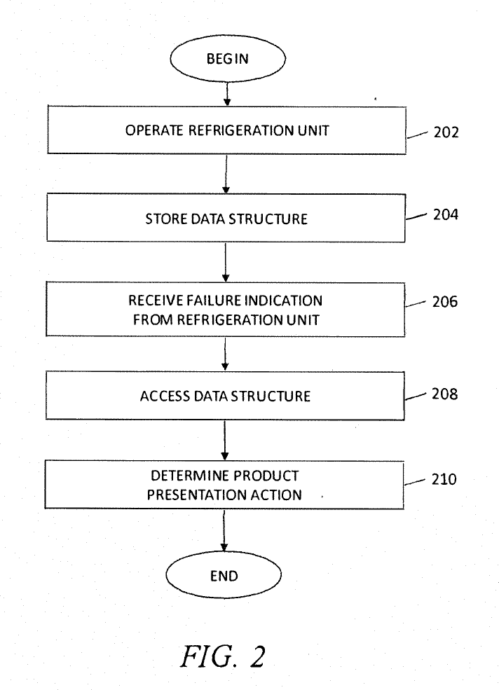

Referring now to FIG. 2, an approach for taking action upon the failure of a refrigeration unit at a vehicle is described. At step 202, a refrigeration unit is operated in a vehicle. The refrigeration unit is configured to maintain a predetermined temperature for a product within a storage area of the vehicle.

At step 204, a data structure is stored at a central processing center. The data structure includes product information concerning financial characteristics and physical characteristics of the product, and destination location information indicating geographic coordinates of potential destinations for placement the product. In aspects, the product information includes one or more of: the cost of the product, the profitability of the product, and the demand for the product, the dimensions of the product, and the cooling requirements of the product. Other examples are possible.

At step 206, and at the central processing center, a failure indication indicating that the refrigeration unit has failed is received. The failure indication may be an electronic signal or message in any convenient format or protocol that indicates that the refrigeration unit has failed and received from a failure detection sensor. In aspects, the failure detection sensor may sense temperature (e.g., whether the temperature has risen above a predetermined level) or whether mechanical parts are properly operating (e.g., whether a fan is operating properly). In examples, the information detected by the failure detection sensor is indicative of failure of the refrigeration unit. In other examples, the information from the sensor is processed and an absolute determination is made as to whether failure has occurred.

At step 208, the data structure in the database is accessed to obtain the product information and the destination location information. At step 210, a product preservation action is determined based upon an analysis of the product information and the destination location information associated with the product.

In aspects, the product preservation action at least in part by determining whether one or more of the following conditions exist: (a) a financial characteristic of the product exceeds a first threshold; (b) a potential location is located more than a threshold distance from a current location of the product; and (c) a physical characteristic of the product exceeds a second threshold. The physical characteristics may include the dimensions or cooling requirements of the product to mention two examples.

To take one specific example, if an expensive product (e.g., a premium ice cream) exceeds a threshold of $5/unit; a potential destination is within 5 miles of the current location of the vehicle, then the action may be to route the vehicle to the destination. In another example, the product is the premium ice cream, the cooling requirements are that the ice cream must be maintained at 10 degrees Fahrenheit or below, and the nearest destination is 250 miles away. In this case, the decision may be to discard the product. It will be appreciated that these are only two examples of decisions that can be made based on representative factors and that other decisions and factors are possible and may be considered.

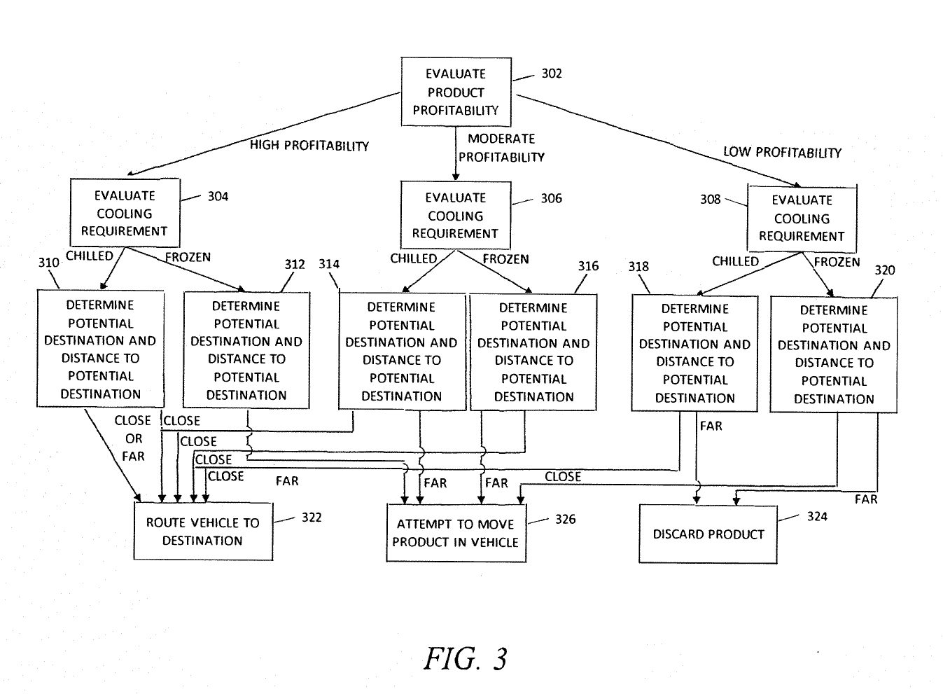

Referring now to FIG. 3, one example of an approach for determining a preservation action is described. In this example, a financial characteristic (profitability) is considered. Additionally, whether a potential location is located more than a threshold distance from the current location of the product (or vehicle) is considered. Finally, a physical characteristic (cooling requirement) of the product is also considered. In examples, the approach of FIG. 3 is executed at a central processing center (e.g., the central processing center 114 of

FIG. 1 where the control circuit 108 implements the approach). In other examples, the approach is implemented at the vehicle where the product is located. In yet other examples, the approach of FIG. 3 is implemented partially at the vehicle and partially at a central processing center.

At step 302, the profitability of the product is considered. In aspects, the profitability is a historic value of how profitable a product is to an enterprise. The profitability may be expressed as an absolute dollar amount, a percentage, or any other convenient mathematical expression. In the example of FIG. 3, the profitability is expressed as “high,” “moderate,” or “low.” For example, high profitability is a profitability of above a predetermined first threshold; a moderate profitability is a profitability between the first threshold and a second threshold; and a low profitability is a profitability that is below the second threshold. The profitability of products may be stored in an appropriate database (e.g., the database 106 of FIG. 1).

If the profitability of a product is high, execution continues with step 304. If the profitability of a product is moderate, control continues with step 306. If the profitability of a product is low, execution continues with step 308.

At steps 304, 306, and 308, the cooling requirements of the product are evaluated. In the example of FIG. 3, the cooling requirements may be either that the product requires chilled conditions (e.g., the temperature is between a first temperature threshold and a second temperature threshold), or that the product requires frozen conditions (e.g., at or below a third temperature threshold). The cooling requirements of products may be stored in an appropriate database (e.g., the database 106 of FIG. 1).

If the product requires chilled conditions at step 304, then execution continues at step 310. If the product requires frozen conditions at step 304, then execution continues at step 312.

If the product requires chilled conditions at step 306, then execution continues at step 314. If the product requires frozen conditions at step 306, then execution continues at step 316.

If the product requires chilled conditions at step 308, then execution continues at step 318. If the product requires frozen conditions at step 308, then execution continues at step 320.

Steps 310, 312, 314, 316, 318, and 320 evaluate the current distance the vehicle is from a potential destination where the truck can be routed (or in some cases, re-routed). To do so, these steps determine the potential destination. In aspects, the potential destination may be an original destination (a destination where the product was originally intended to be shipped), or a substitute destination (a destination where the product may be rerouted from the original destination). Destinations may also be retail stores, warehouses, offices, or homes to mention a few examples. Other examples of destinations are possible.

In aspects, the potential destination may be determined as the closest destination the truck can reach from its current position based upon an evaluation of all potential destinations. For example, a list of all warehouses, retail stores, and distribution centers within a predetermined distance of the truck may be determined, and the warehouse, retail store, or distribution center within the closest distance to the truck may be selected as the potential destination. In other examples, the difficulty in reaching the destination may also be considered in selecting the potential destination. For example, when the potential destination is located in a large urban area with heavy traffic, other destinations that are further from the vehicle may be selected as the potential destination. Traffic and weather conditions may also be considered in selecting the potential destination. For example, destinations at the same approximate distance may be differentiated based upon the traffic and weather conditions present in reaching these destinations. It will be understood that steps 310, 312, 314, 316, 318, and 320 may determine a potential destination according to the same approach or according to different approaches. The coordinates of potential destinations may be stored in an appropriate database (e.g., the database 106 of FIG. 1).

In the example of FIG. 3, the potential destination is classified as “close” or “far.” For example, the destination may be classified as “close” when the number of miles from the current position of the vehicle to the potential destination is below a first predetermined distance threshold. The potential destination is classified as “far” when the destination is at or above a second predetermined distance threshold from the vehicle to the potential destination. In some examples, the first and second predetermined distance thresholds are the same value. In other examples, the distance from the vehicle to the potential destination may be classified as “close,” “medium,” or “far” where “medium” distances are between “close” and “far” distances.

If the answer at step 310 is either close (e.g., at or below a distance threshold) or far (i.e., above the distance threshold), execution continues at step 322. If the answer at step 312 is that the destination is close, then execution continues at step 322. If the answer at step 312 is that the destination is far, then execution continues at step 326.

If the answer at step 314 is that the destination is close, then execution continues at step 322. If the answer at step 314 is that the destination is far, then execution continues at step 326.

If the answer at step 316 is that the destination is close, then execution continues at step 322. If the answer at step 316 is that the destination is far, then execution continues at step 326.

If the answer at step 318 is that the destination is close, then execution continues at step 322. If the answer at step 318 is that the destination is far, then execution continues at step 324.

If the answer at step 320 is that the destination is close, then execution continues at step 326. If the answer at step 320 is that the destination is far, then execution continues at step 324.

Step 322 is executed by the vehicle proceeding to the destination identified in any of steps 310, 312, 314, 316, 318, or 320. An electronic message may be sent to the driver instructing the driver to continue to the destination.

Step 324 is executed by the products being discarded. An electronic message may be sent to the driver instructing to discard the products.

Step 326 is executed by rearranging the products in the truck to preserve the products. For example, the products may be moved from one section or zone of the truck to another zone or section. An electronic message may be sent to the driver instructing the driver to rearrange the products and specifying how the products should be rearranged.

In this way, the profitability of a product, the cooling requirements of a product, and the distance the product is located from a potential destination are used to determine a product preservation action. It will be understood that the example of FIG. 3 is only one example of an approach for determining a product preservation action, and that other factors, combinations of factors, and different weighting of factors may be considered.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system of re-routing vehicles carrying refrigerated products in the event of a refrigeration failure, the system comprising:
a communication network;
a vehicle that includes a transceiver circuit, the transceiver circuit being communicatively coupled to the network, the vehicle also including a refrigeration unit that is configured to maintain a predetermined temperature for a product within a storage area of the vehicle, the vehicle also including a failure detection sensor configured to detect an operational failure of the refrigeration unit;
a database disposed at a central processing center, wherein the database stores a data structure, and the data structure includes:
product information concerning financial characteristics and physical characteristics of the product;
destination location information indicating geographic coordinates of potential destinations for placement the product;
a control circuit disposed at the central processing center, the control circuit being communicatively coupled to the network, wherein the control circuit is configured to:
receive a failure indication indicating that the refrigeration unit has failed, the failure indication being detected by the sensor and received from the transceiver circuit of the vehicle via the network;
access the data structure in the database and obtain the product information and the destination location information;
determine a product preservation action based upon an analysis of the product information and the destination location information associated with the product.

2. The system of claim 1, wherein the control circuit determines a product preservation action at least in part by determining whether one or more of the following conditions exist: (a) a financial characteristic of the product exceeds a first threshold; (b) a potential location is located more than a threshold distance from a current location, the threshold distance corresponding to the product; and (c) a physical characteristic of the product exceeds a second threshold.

3. The system of claim 1, wherein the product information includes one or more of: a cost of the product, a profitability of the product, and a demand for the product.

4. The system of claim 1, wherein the product information includes one or more of: dimensions of the product and cooling requirements of the product.

5. The system of claim 1, wherein the failure indication indicates one of a complete failure or partial failure.

6. The system of claim 1, wherein the failure indication indicates one or more of: a status of the refrigeration unit, a temperature of the air being produced by the refrigeration unit, or a temperature of the storage area.

7. The system of claim 1, wherein the storage space is divided into multiple zones.

8. The system of claim 1, wherein the database is further configured to store environmental factors, the environmental factors including an outside temperature that is external to the vehicle, and wherein the environmental factors are considered in the analysis.

9. The system of claim 1, wherein the product preservation action is one of: re-routing the vehicle and any accompanying product invoicing data in an inventory tracking system from an original destination to a new destination, moving the product within the vehicle, or discarding the product.

10. The system of claim 1, wherein the vehicle is divided into a first zone and a second zone, the product is disposed in the first zone and a second product is disposed in a second zone, and wherein the control circuit is configured to determine a preservation priority as between preserving the product and the second product.

11. A method for re-routing vehicles carrying refrigerated products in the event of a refrigeration failure, the system comprising:
operating a refrigeration unit in a vehicle, the refrigeration unit being configured to maintain a predetermined temperature for a product within a storage area of the vehicle;
storing at a data structure at a central processing center, and the data structure including product information concerning financial characteristics and physical characteristics of the product, and destination location information indicating geographic coordinates of potential destinations for placement the product;
sensing an operational failure of the refrigeration unit by a failure detection sensor, and responsively creating a failure indication;
at the central processing center, receiving the failure indication indicating that the refrigeration unit has failed;
accessing the data structure in the database to obtain the product information and the destination location information;
determining a product preservation action based upon an analysis of the product information and the destination location information associated with the product.

12. The method of claim 11, wherein the step of determining a product preservation action comprises determining whether one or more of the following conditions exist: (a) a financial characteristic of the product exceeds a first threshold; (b) a potential location is located more than a threshold distance from a current location, the threshold distance corresponding to the product; and (c) a physical characteristic of the product exceeds a threshold.

13. The method of claim 11, wherein the product information includes one or more of the cost of: the product, the profitability of the product, and the demand for the product.

14. The method of claim 11, wherein the product information includes one or more of: dimensions of the product and cooling requirements of the product.

15. The method of claim 11, wherein the failure indication indicates one of a complete failure or partial failure.

16. The method of claim 11, wherein the failure indication indicates one or more of: a status of the refrigeration unit, a temperature of the air being produced by the refrigeration unit, or a temperature of the storage area.

17. The method of claim 11, wherein the storage space is divided into multiple zones.

18. The method of claim 11, further comprising storing environmental factors at the database, the environmental factors including an outside temperature that is external to the vehicle, and wherein the environmental factors are considered in the analysis.

19. The method of claim 11, wherein the product preservation action is one of: re-routing the vehicle and any accompanying product invoicing data in an inventory tracking system from an original destination to a new destination, moving the product within the vehicle, or discarding the product.

20. The method of claim 11, wherein the vehicle is divided into a first zone and a second zone, the product is disposed in the first zone and a second product is disposed in a second zone, and wherein the control circuit is configured to determine a preservation priority as between preserving the product and the second product.
